(19) United States
(12) Patent Application Publication
(10) Pub. No.: US 2018/0261418 A1
(43) Pub. Date: Sep. 13, 2018

(54) CUT-OFF ELEMENT AND OVERVOLTAGE PROTECTION ARRANGEMENT

(71) Applicant: Phoenix Contact GmbH & Co. KG, Blomberg (DE)

(72) Inventors: Rainer Durth, Horn-Bad Meinberg (DE); Thomas Meyer, Ottenstein (DE); Jan-Erik Schmutz, Detmold (DE)

(73) Assignee: Phoenix Contact GmbH & Co. KG, Blomberg (DE)

(21) Appl. No.: 15/912,945

(22) Filed: Mar. 6, 2018

(30) Foreign Application Priority Data
Mar. 9, 2017 (DE) 10 2017 105 029.9

(51) Int. Cl. H01H 85/02; H01H 85/17; H01H 85/36; H01H 85/041; H01H 85/34; H01C 7/12

(52) U.S. Cl. CPC H01H 85/0241; H01H 85/17; H01H 85/36; H01H 85/0411; H01H 2085/383; H01C 7/12; H01H 2085/0275; H01H 2085/0216; H01H 2203/028; H01H 85/34

(57) ABSTRACT

A cut-off element for electrical isolation of an electrical component or for opening of a circuit in overload has two terminal contacts, an insulating housing and a fuse element which is located within the insulating housing. In the normal state of the cut-off element, the two terminal contacts (2,3) are connected to one another in an electrically conductive manner via the fuse element. In the cut-off element, reliable isolation of an electrical component, in particular an overvoltage arrangement, is possible by the insulating housing being formed of two parts which are connected to one another and the first part of the housing, in case of overload, being isolated from the second part of the housing so that the connection of the two terminal contacts is broken via the fuse element.

### BACKGROUND OF THE INVENTION

### Field of the Invention

The invention relates to a cut-off element for electrical isolation of an electrical component or for interruption of a circuit in overload, with two terminal contacts, with an insulating housing and a fuse element which is located within the insulating housing. In the normal state of the cut-off element, the two terminal contacts are connected to one another in an electrically conductive manner via the fuse element.

In addition, the invention relates to an overvoltage protection arrangement with at least one overvoltage-limiting component, in particular a varistor, with two connecting elements for electrical connection of the overvoltage protection arrangement to the current path or signal path which is to be protected, and with one thermally opening connection, in the normal state of the overvoltage protection arrangement the overvoltage-limiting component being in electrically conductive contact with the connecting element via the thermally opening connection and the thermally opening connection interrupting when the temperature of the overvoltage-limiting component exceeds a temperature limit.

### Description of Related Art

Cut-off elements for electrical isolation of an electrical component or for interrupting a circuit in overload are known from the prior art in a host of configurations for example as fusible links. Fusible links protect lines and devices from overload and short circuit. Generally fusible links consist of an insulating body which accommodates two electrical contacts or wire terminations which are connected by a thin conductor, the fuse element. The fuse element heats up due to the current flowing through it and melts when a given current intensity is exceeded for a certain time. So that a fuse can reliably activate in case of a short circuit, it is important for its breaking capacity not be exceeded. The breaking capacity is the maximum short circuit current to be expected which the fuse can still reliably cut off without an arc remaining or the fuse itself being destroyed. Often fusible links are also provided with an arc extinguishing medium for extinguishing an arc. The arc extinguishing medium is often quartz sand.

Fusible links are also often used in overvoltage protection arrangements. But one disadvantage of fusible links is the poor signaling capacity for the case in which they have triggered. If the fuse element is additionally surrounded by an arc extinguishing medium it is difficult to recognize whether the fuse element is already split or is still intact. Thus, for a user, it cannot be easily ascertained, and in particular from a remote location, whether an overvoltage protection arrangement has been isolated by an activated fuse. Moreover, with a fusible link, damage to the overvoltage protection arrangement due to aging can only be detected with difficulty since the leakage current which is generally flowing via the overvoltage protection arrangement is not so great that the fusible link triggers.

Therefore, in overvoltage protection arrangements, thermal isolation apparatus are often used as cut-off elements which are based on the breaking of a soldered connection. German Utility Model DE 20 2004 006 227 U1 and corresponding U.S. Pat. No. 7,411,769 B2 disclose an overvoltage protection arrangement with a thermal isolation apparatus in which, when the varistor overheats, a soldered connection which is provided between the varistor and a disconnecting element, is broken; this leads to electrical isolation of the varistor. Moreover, when the soldered connection is broken, the plastic element is pushed by the reset force of a spring out of a first position into a second position in which the disconnecting element which is made as an elastic metal tongue is thermally and electrically separated from the varistor by the plastic element so that an arc which may arise between the metal tongue and the contact site of the varistor is extinguished. Since the plastic element has two colored markings located next to one another, it also acts at the same time as an optical state indication so that the state of the overvoltage protection element can be easily read on site. In addition, the state of the overvoltage protection element can also be indicated by a remote indication contact which is actuated by the plastic element.

However, one disadvantage of thermal isolation apparatus is their limited breaking capacity and their relative inertia. At high surge currents or short circuit current this can lead to the overvoltage protection element being destroyed before the thermal isolation apparatus has separated due to heating of the overvoltage protection element. In order to ensure high insulation and tracking resistance and to extinguish an arc which arise when the gap opens, i.e., when the soldered connection between the disconnection element and the terminal of the varistor is broken, a distance as great as possible must be achieved between the disconnection element and the terminal of the varistor. But, this is often not possible due to the restricted installation conditions so that line follow current cannot be extinguished; this can lead to complete destruction of the overvoltage protection arrangement.

### SUMMARY OF THE INVENTION

Therefore, the object of this invention is to provide a cut-off element as described at the beginning, in which the aforementioned disadvantages are avoided and which ensures reliable isolation of an electrical component. Moreover, an overvoltage protection arrangement will be developed such that, even at high surge currents, reliable isolation of the overvoltage protection arrangement is ensured.

This object is achieved in the initially described cut-off element with the features described herein in that the insulating housing is formed of two parts which are connected to one another and that the first part of the housing, in case of overload, can be isolated from the second part of the housing so that the connection of the two terminal contacts is broken via the fuse element.

It is thus possible in accordance with the invention that the two terminal contacts can be spaced relatively far apart, but structurally efficiently, from one another. Thus, an arc which may arise when the fuse element is interrupted or fused can be extinguished due to the distance of the two terminal contacts from one another.

According to one advantageous configuration of the cut-off element in accordance with the invention, the first part of the housing in the normal state is laminated or cemented to the second part of the housing. In this way, first of all, the two housing parts are easily connected securely to one another. Upon fusing, the fuse element passes through the three aggregate states—solid, liquid, gaseous. In doing so, both the temperature and also the pressure within the housing rise. Pressure and temperature rise to a value at which the forces of adhesion between the two housing parts are no longer sufficient to maintain the connection between the two housing parts so that one housing part “peels” off the other housing part. By the choice of the cement and/or the composition of the fuse element, a predefined breaking capacity can be achieved. Due to the high temperature within the housing, as a result of the heating of the fuse element, the connection of the two housing parts is broken. The additional pressure rise intensifies this effect so that intentional separation of the two parts of the housing occurs.

According to another advantageous configuration of the fuse element in accordance with the invention, it is provided that the first part of the housing and the second part of the housing each consist of a base material for printed-circuit boards, a fiber-reinforced plastic, in particular FR-4. The base material has at least one plated-through hole via which the connection between the terminal contacts and the fuse element takes place. A conventional base material for printed-circuit boards which is a composite of epoxy resin and fiber glass fabric acts as a housing material to be insulating and is especially poorly flammable so that when the fuse element is interrupted between the housing parts the adjacent components are not damaged.

In another configuration of the invention, it is provided that the base materials are joined flat to one another and the plated-through holes are arranged offset to one another. The plated-through holes are connected to one another via the fuse element which is located between the two base materials. The offset arrangement of the plated-through holes can enable a distance as great as possible between the terminal contacts without the thickness of the cut-off element having been chosen to be correspondingly large. In this way, among others, the length and width of the fuse element can also be chosen such that the heat evolution within the housing is uniformly distributed. By means of the plated-through hole, the two terminal contacts are also connected to one another on the opposite outer sides of the housing or of the two parts of the housing.

According to another advantageous configuration of the invention, in the housing there is an arc extinguishing medium which surrounds the fuse element. The arc extinguishing medium which can be for example quartz sand is used for cooling and thus extinguishing an arc which can arise when the fuse element melts or vaporizes. By the cooling or the extinguishing of the arc, the current flow via the cut-off element is interrupted and re-ignition is effectively prevented when the current returns.

In an overvoltage protection arrangement with at least one overvoltage-limiting component, with two connecting elements for electrical connection of the overvoltage protection arrangement to the current or signal path which is to be protected, and with a thermally opening connection it is provided that a cut-off element in accordance with the invention according to one of the aforementioned configurations is located in the overvoltage protection arrangement.

In the normal state of the overvoltage protection arrangement, the overvoltage-limiting component is in electrically conductive contact with one connecting element via the thermally opening connection, the thermally opening connection interrupting when the temperature of the overvoltage-limiting component exceeds a temperature limit. In the normal state of the overvoltage protection arrangement, moreover, the first terminal contact of the cut-off element is connected to one connecting element in an electrically conductive manner, the second terminal contact of the cut-off element is connected in an electrically conductive manner via the thermally opening connection to the overvoltage-limiting component, and the two terminal contacts are connected to one another in an electrically conductive manner via the fuse element.

In the overvoltage protection arrangement in accordance with the invention, the thermally opening connection and the cut-off element are mechanically and electrically connected in series, as a result of which the respective disadvantages of a thermal gap and a fusible link are for the most part avoided. In the case of a pulse-like surge current, the thermally opening connection is generally too slow to open before the overvoltage protection arrangement is destroyed. In this case, however, the cut-off element activates by the fuse element melting or vaporizing, as a result of which the overvoltage protection arrangement is electrically isolated. As the overvoltage protection arrangement gradually heats up due to aging or a minor voltage rise or a leakage current which would not lead to melting of the fuse element, the thermally opening connection responds when the overvoltage-limiting component has exceeded a temperature limit.

In one advantageous development of the overvoltage protection arrangement in accordance with the invention, it is provided that a force acts on the cut-off element so that in case of an overload the cut-off element is separated from the overvoltage-limiting component and/or the first part of the housing is separated from the second part of the housing of the cut-off element. As was explained above, there are two possibilities for how the electrical connection of the overvoltage protection arrangement can be interrupted. In the first case, the thermally opening connection activates, via which the overvoltage-limiting component is connected to the cut-off element. In this case, if the cut-off element is exposed to a force which is directed away from the overvoltage-limiting component, the entire cut-off element is then detached from the overvoltage-limiting component and is moved away from the overvoltage-limiting component. In the case in which the cut-off element triggers and the first part of the housing is isolated from the second part of the housing, the part of the housing which is connected via the thermally opening connection to the overvoltage-limiting component remains in place, i.e., connected to the overvoltage-limiting component. But the other part of the housing is moved away from the overvoltage-limiting component due to the force acting on the former. In both cases a relatively great distance arises between the two components which form the gap, the overvoltage-limiting component and one part of the housing or the two parts of the housing, so that an arc cannot arise in the gap or an existing arc is extinguished by the separation.

According to one preferred configuration, there is a spring element by which the force which acts on the first part of the housing of the cut-off element is produced. Depending on the construction of the overvoltage protection arrangement, the spring element can be a helical spring, an elastic arm or a similar configuration which makes it possible for one part of the cut-off element or the entire cut-off element to be moved out of its original position.

According to another configuration of the overvoltage protection arrangement in accordance with the invention, it is provided that the overvoltage protection arrangement is located in a housing, the housing having an inspection port in the region of the cut-off element. The inspection port is made and arranged here such that a change in the position of the cut-off element or of one part of the housing of the cut-off element can be recognized through the opening. This development of the overvoltage protection arrangement allows the user to recognize whether the overvoltage protection arrangement has been electrically isolated or not. This is advantageous to the user since in this way it can be easily recognized whether the overvoltage protection arrangement needs to be replaced.

For this purpose, the inspection port can be made and arranged such that the cut-off element or the first part of the housing of the cut-off element is only visible in the inspection port when the overvoltage protection arrangement is in the normal state, i.e., when neither the thermally opening connection nor the cut-off element has activated. Alternatively, the inspection port can also be made and arranged such that the cut-off element or the first part of the housing of the cut-off element is only visible in the inspection port when the overvoltage protection arrangement is not in the normal state, i.e., when the thermally opening connection or the cut-off element has triggered.

In this connection, it is also possible for the cut-off element when moved out of the first position (normal state of the overvoltage protection arrangement) to be routed into the second position. This can be accomplished, for example, by a guide rail or similar configuration. At the level of the inspection port there can be a corresponding stop so that the cut-off element or a part of the cut-off element in the second position is moved to the height of the inspection port.

Another configuration of the overvoltage protection arrangement calls for the front end of the first part of the housing facing the inspection port to be visually distinguishable from the front end of the second part of the housing facing the inspection port. The front ends can preferably have different colors. In this way, there is good signaling capacity for the two possible versions of cut-off of the overvoltage protection arrangement. The front ends need not necessarily have different colors. They can also differ optically in their composition and/or structure. In one case, if only the first part of the cut-off element is being moved into the second position, the user can see in the inspection port, for example, only the first part of the cut-off element. For the case in which the thermally opening connection triggers, the user then sees the entire cut-off element in the inspection port.

In particular, there is at this point a host of possibilities for embodying and developing the cut-off element in accordance with the invention as well as the overvoltage protection arrangement. For this purpose, reference is made to the following description in conjunction with the accompanying drawings.

### BRIEF DESCRIPTION OF THE DRAWINGS

FIG. 1 shows a simplified representation of one cut-off element in a sectional view, and

FIG. 2 shows a simplified representation of an overvoltage protection arrangement, with a cut-off element according to FIG. 1.

### DETAILED DESCRIPTION OF THE INVENTION

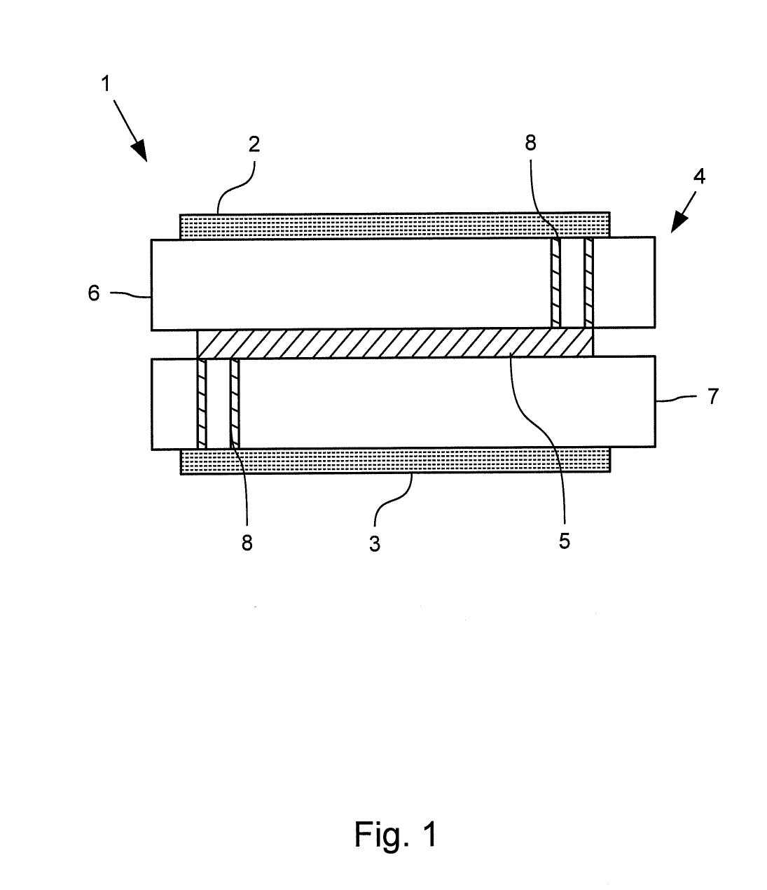

FIG. 1 shows a cut-off element 1 with two terminal contacts 2, 3. The cut-off element 1 has an insulating housing 4 in which a fuse element 5 is embedded. The housing 4 is formed of a first part 6 and a second part 7, the two housing parts 6, 7 each comprise a base material of the type used for printed-circuit boards. The base material is a composite of an epoxy resin and a fiber glass fabric. The base material acts to insulate so that the current can only be transmitted via the terminal contacts 2, 3 and the fuse element 5. The two housing parts 6, 7 additionally each have a plated-through hole 8 so that the two terminal contacts 2, 3 in the normal state are connected to one another in an electrically conductive manner via the plated-through holes 8 and the fuse element 5.

The two parts 6, 7 are cemented to one another so that the cut-off element 1 is made as a type of printed-circuit board whose top (terminal contact 2) and bottom (terminal contact 3) are electrically connected to one another via the fuse element 5. When the fuse element 5 heats up due to a high flowing current, both the pressure and the temperature within the housing 4 rise. When the fuse element 5 has been heated up to such an extent that it vaporizes, the pressure and temperature in the housing 4 are so great that the adhesive action is no longer sufficient to keep the two housing parts 6, 7 together. In this way the housing 4 “peels” off and the printed-circuit board delaminates and the two parts 6, 7 of the housing 4 are separated from one another. This leads to the electrical connection between the two terminal contacts 2, 3 being interrupted via the fuse element 5. Moreover, by separating the two parts 6, 7 and thus also the two terminal contacts 2, 3, an arc which may arise when the electrical connection opens is also extinguished.

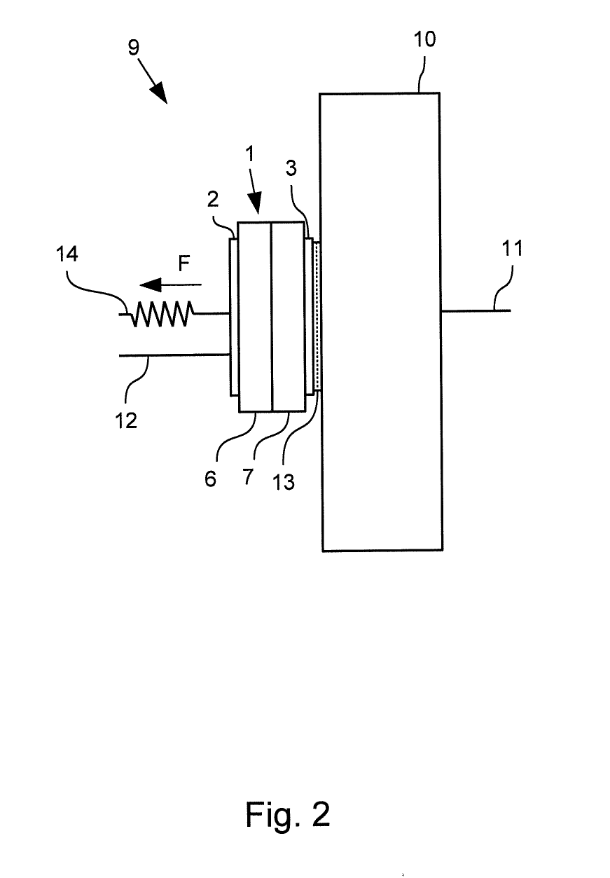

FIG. 2 shows an overvoltage protection arrangement 9 with a cut-off element 1 according to FIG. 1. The cut-off element 1 is connected in an electrically conductive manner to an overvoltage-limiting component 10, in this case, a varistor. The overvoltage protection arrangement 9 has two connecting elements 11, 12 with which the overvoltage protection arrangement 9 can be connected to the current path or signal path which is to be protected. The cut-off element 1 is connected to the varistor 10 via a thermally opening connection 13.

The thermally opening connection 13, which is made as a soldered connection, triggers when the varistor 10 is overly heated due to aging or small overvoltages. This opens the electrical connection between the cut-off element 1 and the varistor 10, as a result of which the overvoltage protection arrangement 9 is electrically isolated. In the case of a pulse-like surge current, the cut-off element 1 triggers by the fuse element 5 melting or vaporizing. In this way, the electrical connection between the connecting element 12 and the terminal contact 3, and thus, also between the connecting element 12 and the varistor 10, is interrupted so that the overvoltage protection arrangement 9 is likewise electrically isolated. In the case of a pulse-like surge current, the thermally opening connection 13 alone would be too slow to isolate the overvoltage protection arrangement 9 in time before the varistor 10, and thus, also the overvoltage protection arrangement 9, are altogether destroyed.

On the first terminal contact 2 of the cut-off element 1 and on the side of the cut-off element 1 facing away from the thermally opening connection 13 there is a spring element 14 which applies a force to the cut-off element 1 which is directed away from the thermally opening connection 13. At this point, if the cut-off element 1 or the thermally opening connection 13 triggers, the isolated part 6 of the cut-off element 1 or the entire cut-off element 1 is moved away from the overvoltage-limiting component 10 by the force of the spring element 14, as a result of which a relatively great distance arises between the two components which form the gap, the overvoltage-limiting component 10 and one part 7 of the housing 4 or the two parts 6, 7 of the housing 4 so that an arc which may form when the electrical connection is opened is extinguished.

Because the cut-off element 1 is made as a type of printed-circuit board material, it can have very small dimensions and can be easily connected to the varistor 10 via its terminal contact 3 and the soldered connection 13.

The amount of space which is required for the arrangement of the cut-off element 1 in the housing of the overvoltage protection arrangement 9 is thus very small.

What is claimed is:

1. A cut-off element for electrical isolation of an electrical component or for opening of a circuit in overload, comprising:
two terminal contacts,
an insulating housing and
a fuse element which is located within the insulating housing,
wherein, in a normal state of the cut-off element, the two terminal contacts are connected to one another in an electrically conductive manner via the fuse element,
wherein the insulating housing is formed of two parts which are connected to one another, and
wherein a first part of the housing is isolated from the second part of the housing in case of an overload so that the connection of the two terminal contacts via the fuse element is broken.

2. The cut-off element in accordance with claim 1, wherein the first part of the housing in the normal state is laminated or cemented to the second part of the housing.

3. The cut-off element in accordance with claim 1, wherein the first part of the housing and the second part of the housing are each made of a printed-circuit boards base material having at least one plated-through hole.

4. The cut-off element in accordance with claim 3, wherein the printed-circuit boards base material is FR-4.

5. The cut-off element in accordance with claim 3, wherein the parts of the housing are joined via flat surfaces, wherein said at least one plated-through hole of one of the first and second housing parts is arranged offset to the at least one plated-through hole of the other of the first and second housing parts, and wherein the fuse element connects the plated-through holes to one another, the fuse element being located between the first and second housing parts.

6. The cut-off element in accordance with claim 1, wherein an arc extinguishing medium surrounds the fuse element.

7. A overvoltage protection arrangement, comprising:
at least one overvoltage-limiting component,
two connecting elements for electrical connection of the overvoltage protection arrangement to a current or signal path to be protected,
a thermally opening connection, and
a cut-off element,
wherein, in a normal state of the overvoltage protection arrangement, the overvoltage-limiting component being in electrically conductive contact with a connecting element via the thermally opening connection,
wherein the thermally opening connection being constructed to open when the temperature of the overvoltage-limiting component exceeds a temperature limit,
wherein the cut-off element comprises:
two terminal contacts,
an insulating housing and
a fuse element which is located within the insulating housing,
wherein, in a normal state of the cut-off element, the two terminal contacts are connected to one another in an electrically conductive manner via the fuse element,
wherein the insulating housing is formed of two parts which are connected to one another by the fuse element, and
wherein a first part of the housing is isolated from the second part of the housing in case of an overload so that the connection of the two terminal contacts via the fuse element is broken.
wherein, in the normal state of the overvoltage protection arrangement, a first of the terminal contacts of the cut-off element is connected to one of the connecting elements in an electrically conductive manner, and a second of the terminal contacts of the cut-off element is connected in an electrically conductive manner to the overvoltage-limiting component via the thermally opening connection.

8. The overvoltage protection arrangement in accordance with claim 7, further comprising means for applying a force that acts on the cut-off element so that, in case of an overload, the cut-off element is separated from the overvoltage-limiting component or the first part of the housing is separated from the second part of the housing of the cut-off element.

9. The overvoltage protection arrangement in accordance with claim 8, wherein said means for applying a force is a spring element which applies a force to the first part of the housing.

10. The overvoltage protection arrangement in accordance with claim 7, wherein the overvoltage protection arrangement is located in a housing, and wherein the housing has an inspection port in a region of the cut-off element.

11. The overvoltage protection arrangement in accordance with claim 10, wherein a front end of the first part of the housing faces the inspection port and is visually distinguishable from a front end of the second part of the housing which faces the inspection port.

12. The overvoltage protection arrangement in accordance with claim 10, wherein the front ends are distinguishable by each of the ends having a differently colored marking from the other of the ends.

13. The overvoltage protection arrangement in accordance with claim 7, wherein the at least one overvoltage-limiting component comprises a varistor.
